(19) United States
(12) Patent Application Publication
(10) Pub. No.: US 2007/0009716 A1
(43) Pub. Date: Jan. 11, 2007

(54) Coated surface business communication assembly having visually dimensionally distinct patterns for creating transitional images

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/178,678

(22) Filed: Jul. 11, 2005

(51) Int. Cl. B32B 3/00

(52) U.S. Cl. 428/204

(57) ABSTRACT

The present invention relates to dimensionally distinct, business communication assemblies, such as those that may be used in preparing products ranging from prime labels to presentation folders that include a substrate having at least one printed face over which a curable coating is applied. The coating, while still in a relatively fluid state is imparted with a regular, repeating pattern which when cured will create a transitional image when the substrate is viewed at visually, perceptually distinct angles.

### CROSS-REFERENCES TO RELATED APPLICATIONS

None.

### FIELD OF THE INVENTION

The present invention is directed to the field of preparation of stock materials for use in the creation of unique business communication assemblies that have transitional imaging properties imparted to the substrate. More particularly, the instant application relates to the manufacture of coated substrates that can be produced in an economical and efficient fashion to render enhanced surface characteristics to the information handling document, to which the coating has been applied, in order to create dimensionally distinct surface viewing areas. Practice of the present invention can be performed in a continuous fashion, such as in a web format, or alternatively, the business communication documents can be prepared in a sheet wise configuration.

### BACKGROUND OF THE INVENTION

There are wide varieties of product offerings available in the market today that serve multiple purposes and functions, including product offerings that are used in fulfilling the needs of particular market segments and other business communication constructions that are used to convey or handle information.

Printed products, such as pieces that are intended to be used in business communications, can be delivered in a wide variety of formats, constructions and configurations. Normally, one of the most significant limiting factors for a manufacturer being able to produce a particular construction or expand product capabilities is the equipment the manufacturer has on hand to generate such printed pieces or the cost and expense associated with delivering such products.

Traditional manufacturers of business communications, such as business forms and labels, are also usually limited in the type of jobs that a manufacturer will accept based on size of the job, or more particularly the order quantity or value of the order. That is, due to cost factors, a customer will not place an order with a manufacturer for a small to medium sized piece quantity as the set up or make ready of the job makes the order cost prohibitive, even assuming that the manufacturer would accept the order if a particular price could be obtained to justify production.

The foregoing difficulty is largely based on conventional manufacturing techniques that normally utilize webs of material that are successively printed or otherwise treated in order to produce a finished product assembly. As such, small to medium sized runs of product are generally not adaptable to this type of manufacture due to the amount of material (length of a web) that must be used in order to prepare a particular job and manufacture the product in a cost effective manner.

The preparation of products, novelties and printed materials having three dimensional appearances is generally well known and may be described as using lenses that have a series of lenticules that create a perception of a different image when an image is viewed through the lenticules at differing angles. That is, when the substrate on which the lens has been placed is shifted in one's line of sight, the image appears to change due to the angle at which the image is viewed and the distortion caused by the individual lenticules.

Normally, such three dimensional items are produced in relatively limited quantities due to the cost associated with manufacturing the item. For example, distributing products that have various lenticular properties may be limited to certain target markets based on previously determined demographics for it is anticipated that the small, but focused approach will yield a higher return on the investment when compared with blanket mailings.

Historically, products having lenticular properties have been prepared by applying a plastic lens over a printed item, with the lens having preformed lenticules provided therein. The lenticules may be crated through any number of known methods such as by etching, abrading, grinding, etc. The lens is then laminated to a previously prepared image directly, which may have been reverse printed, so that the image is visible through the lens. Shifting of the piece to change the angle or view of the piece then causes the image to appear to change due to the different angles through which the image is viewed.

As might be expected, the cost of preparing a plastic or other resinous material incrementally increases the expense of manufacturing such products. Therefore, typically, multiple dimensional products have been limited to more high value items such as security products, trading or novelty cards, greeting cards, high end promotional activity and the like.

U.S. Pat. Nos. 5,285,238 and 5,457,515 each describe a continuous process in which a curable resinous material is applied to a transparent web, lenticules are created in the material and the material is then cured to fix the lenticules in the web. The web is then affixed to a second web carrying an image so that the image is visible through the lenticular lens that has been created substantially in-situ.

In an alternate embodiment disclosed in U.S. Pat. No. 5,285,238, the resinous coating is applied directly to one side of a single web to create the lenticules and an image applied to a “flat side” opposite the side of the coating without the necessity of laminating the lenticular web to the image web, see abstract. However, the system described still is relatively complex in its application as the imaging must occur at a pre-determined angle to that of the direction of the travel of the web so that the hoped for lenticular affect is obtained.

One of the potential drawbacks of using a curable resin, such as a plastic resin is that the resin may make the underlying image appear cloudy or foggy when viewed at various angles when shifting the image in one's line of sight. This potentially can detract from the overall presentation of the product.

What is needed therefore is an economical and simple to use system in which a coating can be applied in a fashion, ranging from continuous to selective, without the aforementioned drawbacks associated with the prior art systems.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly it has been found that a relatively inexpensive overprint varnish material when applied in a suitable thickness can create a surface similar to lenticular lens used in the past. It has been discovered that a cost effective and simple solution can be used to create printed or imaged business communication substrates that possess lenticular properties without the need to laminate expensive webs or lenses to the printed web. More importantly, the UV curable overprint varnish coating creates a glossy appearance that mimics more expensive plastic or resinous materials creating an economical alternative to thereby expand the use of the lenticular affect to other areas where it may have been previously unavailable.

In one exemplary embodiment, a business communication assembly that has transitionally distinct viewing angles is described and includes a substrate having first and second faces, first and second transversely extending edges and first and second longitudinally extending sides. A high quality image, such as one having a resolution of greater than 150 lines per inch is applied to at least the first face of the substrate in a first direction that is substantially parallel with a machine direction. The image is applied between the first and second transversely extending edges and first and second longitudinally extending sides.

In the presently described embodiment, a curable overprint varnish that has a thickness ranging from about 0.0002″ to about 0.005″ is applied to the first face of the substrate and directly over the image. The varnish includes a first component that ranges from 0.01% by weight to 99.99% by weight and a second component that ranges from 0.01% by weight to about 99.99% by weight. A pattern is created in the coating in a second direction while the coating is still in a fluid state to create a dimensionally distinct, visually perceptible pattern on the substrate when the substrate is viewed at different angles. The coating is hardened to fix the pattern by curing.

In a still further embodiment of the present invention, a business communication document suitable for use as a prime label that has a multiple dimensional view is presented and includes a sheet that has a first face and a second face. An image is printed in an area on at least the first face of the sheet, the image having a pre-determined resolution. A curable overprint varnish coating is applied directly over the image and at least substantially covering a portion of the area occupied by the image. An adhesive is applied to the second face of the sheet. A pattern is imparted to the coating to create a series of regularly occurring peaks and valleys in the coating such that the pattern provides a transitional image when the image is viewed at different angles. After the coating is cured a prime label having a multiple dimensional view is created.

In a yet still further embodiment of the present invention, a business communication assembly suitable for use as a presentation folder that has a surface having a multiple dimension view is provided and includes a blank of material that has first and second sides, first and second faces and at least one pocket formed in the blank. An image, having a pre-determined resolution, is printed in an area on at least the first face of the blank. A curable overprint varnish coating is applied directly over the image and at least substantially covering a portion of the area that is occupied by the image. A pattern is imparted to the coating to create regularly occurring peaks and valleys in the coating such that the pattern provides a transitional image when the image is viewed at different angles and after the coating is cured to create a presentation folder having a multiple dimensional view in the area of the overcoating.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a side view of a business communication assembly prepared in connection with the present invention;

FIG. 2 illustrates a schematic of process used in the formation of the business communication assembly shown in FIG. 1;

FIG. 3 presents an exemplary use of a business communication assembly prepared in connection with the present invention; and

FIG. 4 shows a further exemplary use of a business communication assembly prepared in connection with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been discovered that patterns can be produced that resemble and function as traditionally produced lenticular assemblies without the need to create expensive overlays, or laminated constructions as heretofore has been previously known. In addition, through the use of the present embodiments it has been discovered that a significantly higher degree of variability can be provided to the end user when preparing intermediates in accordance with the present invention.

Overprint varnishes have historically been used by the printing industry and are usually applied to the surfaces of printed substrates to provide a glossy coating. The coatings are normally applied to create a relatively thin layer so as to not obscure or cloud features of the printing beneath the coating. However, to date, the inventors of the instant application are unaware of the use of such coatings in a relatively thick overcoat to create a substrate having multidimensional properties.

The term “patterns” as used herein refers to continuous strips, lines, shapes, spots, dots, elements, and discontinuous segments as well as regular and irregular placement of such items. Patterns may also refer to combinations of the above mentioned items such that one pattern may be a continuous strip, another segmented elements and yet still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters and the like. For example, one may wish to include a name of a company in connection with a particular theme or season.

Preferably in connection with the present invention, the patterns used to form the lenticular affect, that is the patterns formed in the overprint varnish, will be provided in a regularly occurring arrangement of relatively parallel striations that will be substantially adjacent one another.

The term “basis weight” as used herein is the weight in pounds of a ream (500 sheets) of paper cut to a given standard size for that grade. For example 500 sheets of 8 ½″ by 11″ of bond paper weighs 20 pounds.

As used herein the term “business communication piece or document” is used to refer to a substrate that either alone or in combination with other documents can convey a particular message, image or information about a particular product or service that is available from the provider of such pieces or documents. Business communication documents or pieces can include business forms, stationery, business cards, advertising, sales and marketing collateral and such other items used to convey information in a written or imaged form.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or enhancing the image of the manufacturer or distributor. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The varnish or coating that is used in the present invention may be applied by any conventional means, such as flood coating, pattern or spot coating, transfer coating or other suitable technology known in the industry. The coating may be applied so as to cover the full length and width of the material or substrate or may be applied in predetermined or selected areas so that only a portion of the substrate or sheet is provided with the varnish or coating.

The thickness of the coating ranges from about 0.0002″ to about 0.005″ and more preferably 0.0002″ to about 0.003″ with about 0.002″ being yet still more preferred. Typically, in a preferred embodiment the coating is applied through a coating roller but a flood coat sleeve or printing plate applicator may also be used. A particular range of viscosities is generally not required for the practice of this invention. However, those coatings with a higher viscosity will typically produce a greater contrast between the sheet or substrate and the coating that is employed.

For the exemplary embodiment being presently described, one preferred coating is a UV curable varnish, such as FT30LI available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1), and a vapor pressure of less than 1 (MM HG at 25° C.).

The coating material may comprise 100% of the varnish or the varnish of the exemplary embodiment may contain from 0.01% to 99.99% varnish and then a second component may be provided in a range from 0.01% to 99.99%, with such second coatings including pigments, dies, starches, waxes, silicones, stabilizers, drying aids, fragrances and such other elements or components that may add desirable features or characteristics to the coating.

Other material or components that may be suitable in connection with the coating and with the practice of the present invention include Transwhite 36 and 61 which are available from Arcar Graphics, LLC of West Chicago, Ill. and is water based, pigment less ink that includes butyl alcohol, ammonium hydroxide and n-methylpyrrolidone. Transwhite is generally pigment less, but pigments may be added to supplement or compliment the printing that may be applied to the assembly. NuCoat 8320 is available from NuCoat, Inc. of Plymouth, Minn. which serves as an absorbing agent. PrintAide is available from Arcar Graphics of Ann Arbor, Mich. and includes 2-dimethylaminothanol and ammonia and functions as a drying agent or wetting agent in slowing the drying if necessary. StabilAide may be mixed with water or any other known component or used alone and is available from Arcar Graphics of Ann Arbor, Mich. and is generally used for pH stabilization.

Sericol is available from Sericol of North Kansas City, Kans. and includes acrylate ester, vinaly monomer, acrylated urethane, alkanol amine, barium sulfate and a photoinitator. Sericol is a pigment less material having an absorbing agent contained therein as well as being in a prescribed pH range.

The curing of the coating as used in the present invention is accomplished by at least one if not multiple UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration, can be used. In an exemplary embodiment, a single bulb may allow a UV cure rate of approximate 50 feet per minute, while plural bulbs disposed in a side-by-side or adjacent configuration permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulbs suitable for use in the UV curing processes. However, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention. It should be understood that other curing technologies may be used in the preparation of the coating on the substrate for the present invention.

The exemplary coating, despite the thickness normally will create a glossy finish and can be further manipulated through the addition of pigments, dyes, starches, etc. to produce a dulled or matte finish or a coating having a particular color or appearance in the final product.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

In connection with the embodiment relating to use of the business communication assembly as a presentation folder, each side of the blank will have a width of approximately 9 inches and a length of about 12 inches, the overall width of the blank will be about 18 inches by 12 inches. The pockets formed from the present invention will have a height of around 4″ to 4¼″ and a width of up to 9 inches. The flaps that are provided on each of the panel and pocket portions of the sheet intermediate range from roughly ¼ of an inch up to about 2 inches. The width of the flap used in the sealing of the construction, either the pocket or the sheet to a blank so as to create the folder itself, is dependant upon the dimensions necessary to accomplish the needs of the manufacture to meet the specifications and demands of the customer or end user.

The foregoing dimensions are used when preparing a standard configuration presentation folder. That is, each panel of the blank runs about 12″ high and about 9″ wide with the pocket having a length of about 9″ and a height of around 4″. Obviously, other dimensions are possible and would simply require the repositioning of the adhesive areas, lines of weakness, etc. on the sheet or use of different sized sheets of material. The pocket of the presently described embodiment is sized and configured so that it can receive and retain a standard size sheet of paper in a portrait arrangement (8½″ side placed in the pocket which has a width of approximately 9″).

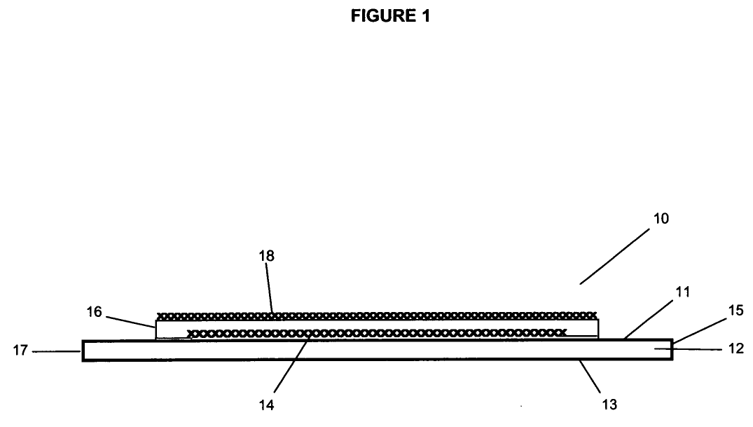

Turning now to FIG. 1 a business communication assembly prepared in connection with the present invention is depicted and is referenced generally by numeral 10. The business assembly 10 includes a substrate 12, which will preferably be a cellulosic based material such twenty-four pound bond paper, fifty to hundred pound tag or board stock or other suitable material. The substrate may also include plastic films or metal foils but it may be necessary to first apply an anchor coating to hold the printing and possibly coating to the surface of the substrate.

The substrate 12 has first and second faces 11 and 13, respectively, first and second longitudinally extending sides 15 and 17 and first and second transversely extending edges (not shown). On the first face 111 of the substrate 12 an image 14 is applied. The image may be textual or may include graphical depictions and may be produced using any suitable rendering device. Preferably, however, the image 14 will be prepared with a high quality device that is capable of producing a depiction of about 150 lines per inch or greater, such as up to 300 lines per inch so that use of the lenticular portion of assembly 10 will have a greater impact on the viewer of the assembly.

Still referring to FIG. 1, a curable overprint varnish coating 16 is applied over the surface 11 of the substrate 12 as well as the image 14. The coating 16 is applied via a coating roller and may be applied over the entire surface 11, that is between the longitudinally extending sides 15 and 17 or alternatively, the coating 16 may be applied only in selected areas to produce different designs or surface treatments.

After the coating 16 has been applied to the surface 11 of the substrate 12, a series of regularly spaced striations 18 are created to form a number of similarly sized peaks and valleys. After forming of the pattern 18 in the coating 16, the coating 16 is cured by ultraviolet energy so as to harden the coating 16 and the pattern 18.

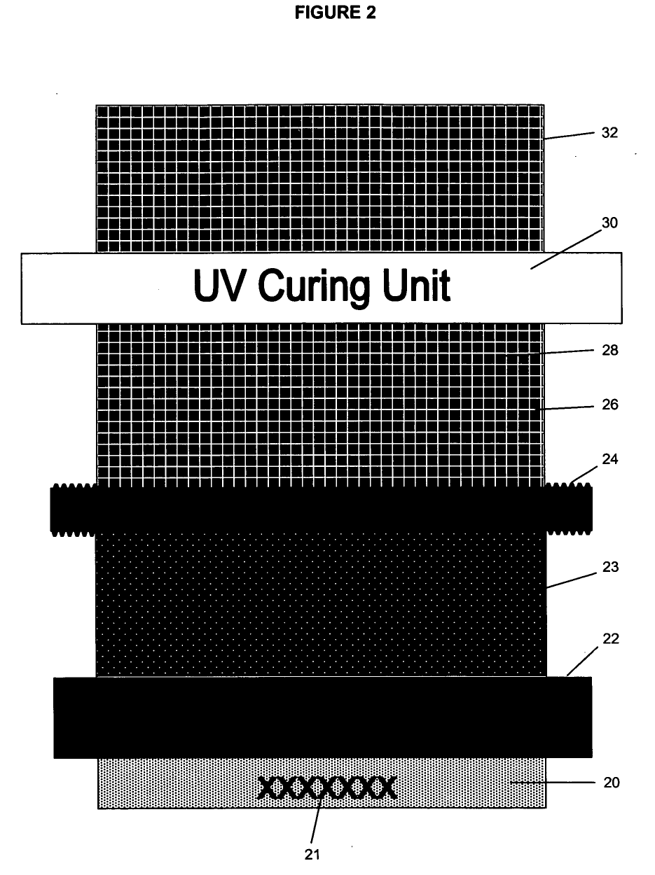

Reference is now directed to FIG. 2 of the present invention, in which a schematic of the apparatus used in the manufacture of the business communication assembly is shown. A substrate 20, in this case a continuous web of material is provided. It should be understood that the invention may be practiced using either a continuous web or alternatively a cut sheet format. The web 20 may be preprinted with indicia 21 which may run substantially parallel to the direction of machine travel or alternatively, the indicia may be printed so that it runs perpendicularly to the direction of machine travel and in which the coating will be applied.

The web 20 is advanced in a machine direction beneath coating roller 22 which applies the coating to the web 20 of material. The thickness of the coating ranges from about 0.0002″ to about 0.005″ and more preferably 0.0002″ to about 0.003″ with about 0.002″ being yet still more preferred. The coated web 23 is then passed, again in a machine direction to an embossing shaft 24. The shaft will preferably be a metal shaft into which a series of regularly spaced grooves have been cut. The grooves will form the pattern in the coated web 23 after the coated web passes beneath the embossed roller 24. Reference numeral 28 shows the coated web with a series of regularly occurring striations 26 disposed in the surface of the web. The striations 26 will function as the individual lenticules upon curing of the coating on the web of material.

The coated web 28 is then passed, again in a machine direction beneath a curing unit 30 which uses ultraviolet energy. Exemplary bulbs used in the embodiment of the present invention are “H” bulbs and Gallium doped bulbs suitable for use in the UV curing processes, however, it should be understood that other UV curing may be used in accordance with the present invention and the present invention is not limited hereto.

The cured web 32 exits the curing station with the hardened coating thereon. The web may then be sheeted, cut into individual sheets, die cut to form shapes (animate, inanimate, geometric, etc.) or may simply be collected in a continuous form for later use and subsequent operation.

An exemplary coating used in connection with the present invention is now set forth in the following Table 1:

| Component | % by Weight |
|---|---|
| UV Curable Varnish | 97% |
| PrintAide ® | 1.5% |
| Corn Starch | 1% |
| Pigment | .5% |
| Total | 100% |

A further exemplary coating used in connection with the present invention is now set forth in the following Table 2:

| Component | % By Weight |
|---|---|
| UV Curable Varnish | 99.9% |
| Pigment | .1% |

A further exemplary coating used in connection with the present invention is now set forth in the following Table 3:

| Component | % By Weight |
|---|---|
| UV Curable Varnish | 98.5% |
| Corn Starch | 1.5% |
| Total | 100% |

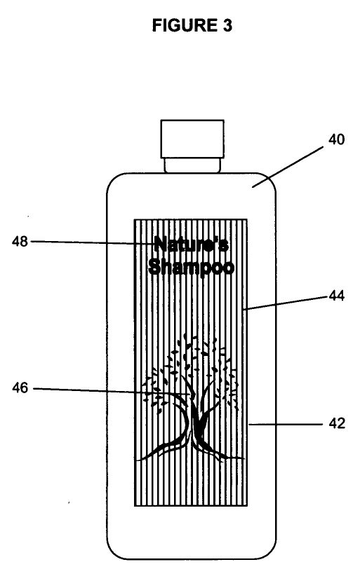

Reference is now directed to FIG. 3 in which one exemplary use of the present invention is provided. A container, such as a consumer package good (“CPG”) 40 is provided with a prime label 42. The label 42 is provided with a series of regularly occurring striations 44 that occur in the surface of a coating that has been previously applied and cured as described herein. The label 42 is also printed with graphical 46 and textual representation 48 prior to the coating so that when the container 40 is shifted in the line of sight of a prospective customer the image itself 42 will shift appearing to change due to the different viewing angles created by the striations 44 in the surface coating. In the present example, use of the overprint varnish will aid in marketing the product as the varnish will have a generally glossy appearance.

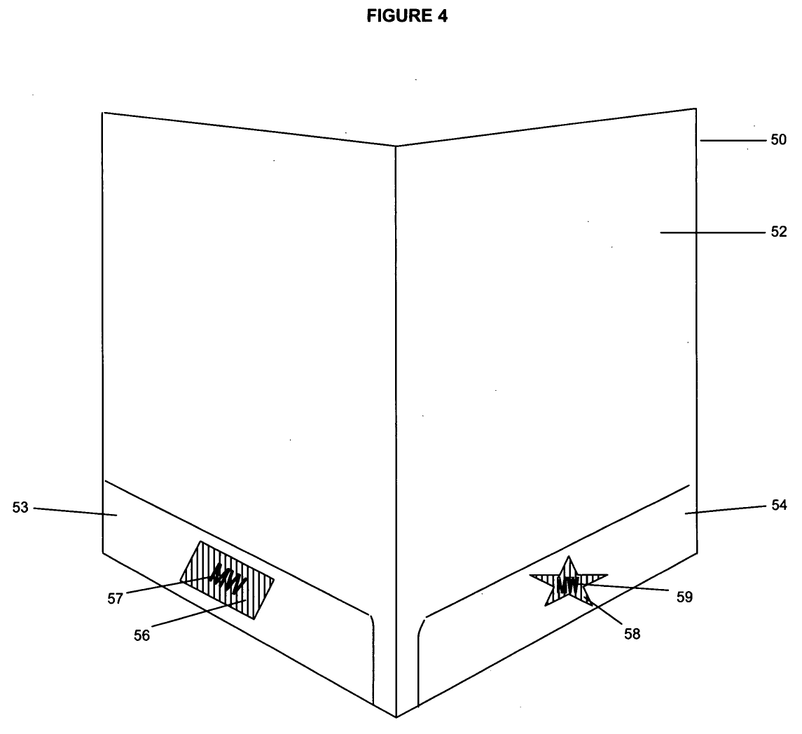

FIG. 4 provides a further exemplary use of a business communication assembly that has been prepared in accordance with the present invention. In this embodiment, a presentation folder generally depicted by reference numeral 50 is provided with a first face 52 and second face which is opposite the first face and not shown in the present drawing.

The presentation folder 50 is provided with at least one pocket 54, but generally such constructions will contain plural pockets, with the second pocket represented by numeral 53. On each of the pockets 53 and 54 a business communication assembly has been provided and are represented generally by numerals 56 and 58. Assembly 56 has been provided with printing 57 as has assembly 58 which is represented by numeral 59. In this way, upon opening the presentation folder 50, the recipient will see a first image and then the image will shift when the folder is fully opened due to the striations in the cured pattern provided on each of the assemblies.

It should be understood that the assembly may be placed on either face of the presentation folder 50 and in any position on such faces. The folder may also carry sheets of representative samples of products that have been prepared in accordance with the present invention.

It will thus be seen according to the present invention a highly advantageous coated intermediate having visually, dimensional distinct patterns has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business communication assembly having transitionally distinct viewing angles, comprising;
a substrate having first and second faces, first and second transversely extending edges and first and second longitudinally extending sides;
an image is applied to at least said first face of said substrate in a first direction substantially parallel with a machine direction and between said first and second transversely extending edges and first and second longitudinally extending sides;
a curable overprint varnish having a thickness ranging from about 0.0002″ to about 0.005″ applied to said first face of said substrate and directly over said image, said varnish includes a first component ranging from 0.01% by weight to 99.99% by weight and a second component ranging from 0.01% by weight to about 99.99% by weight; and
wherein a pattern is created in said coating in a second direction while said coating is still in a fluid state to create a dimensionally distinct, visually perceptible pattern on said substrate when viewed at different angles after said coating is hardened by curing.

2. A business communication assembly as recited in claim 1, wherein said coating has a boiling point of greater than 200° C. and a vapor pressure of less than 1 MM HG at 25° C.

3. A business communication assembly as recited in claim 1, wherein said coating said second component selected from a group including pigments, dies, starches, waxes, silicones, stabilizers, drying aids, fragrances and combinations thereof.

4. A business communication assembly as recited in claim 1, wherein said pattern includes a series of regularly repeating striations.

5. A business communication assembly as recited in claim 1, wherein said first direction and said second direction are substantially parallel to one another.

6. A business communication assembly as recited in claim 1, wherein said first direction and said second direction are distinct from one another.

7. A business communication assembly as recited in claim 1, wherein said image is printed with a resolution of at least about 150 lines per inch.

8. A business communication assembly as recited in claim 1, wherein said business communication assembly is a prime label.

9. A business communication assembly as recited in claim 1, wherein said business communication assembly is a presentation folder.

10. A business communication document suitable for use as a prime label that has a multiple dimensional view, comprising;
a sheet having a first face and a second face;
an image printed in an area on at least said first face of said sheet, said image having a predetermined resolution;
a curable overprint varnish coating applied directly over said image and at least substantially covering a portion of said area occupied by said image;
an adhesive applied to said second face of said sheet; and
a pattern imparted to said coating to create a series of regularly occurring peaks and valleys in said coating such that said pattern provides a transitional image when said image is viewed at different angles and after said coating is cured to create a prime label having a multiple dimensional view.

11. A business communication document suitable for use as a prime label as recited in claim 10, wherein said curable varnish coating has a thickness ranging from about 0.0002″ to about 0.005″.

12. A business communication document suitable for use as a prime label as recited in claim 10, wherein said image is printed with a resolution of greater than about 150 lines per inch.

13. A business communication document suitable for use as a prime label as recited in claim 10, wherein said coating has a boiling point of greater than 200° C. and a vapor pressure of less than 1 MM HG at 25° C.

14. A business communication document suitable for use as a prime label as recited in claim 10, wherein said image includes graphical and textual depictions.

15. A business communication document suitable for use as a prime label as recited in claim 10, wherein said coating includes a second component ranging from about 0.01% to about 99.99% of said coating and selected from a group including pigments, dies, starches, waxes, silicones, stabilizers, drying aids, fragrances and combinations thereof.

16. A business communication assembly suitable for use as a presentation folder that has a surface having a multiple dimension view, comprising;
a blank of material having first and second sides, first and second faces and at least one pocket formed in said blank;
an image printed in an area on at least said first face of said blank, said image having a pre-determined resolution;
a curable overprint varnish coating applied directly over said image and at least substantially covering a portion of said area occupied by said image; and
a pattern imparted to said coating to create regularly occurring peaks and valleys in said coating such that said pattern provides a transitional image when said image is viewed at different angles and after said coating is cured to create a presentation folder having a multiple dimensional view.

17. A business communication assembly suitable for use as a presentation folder as recited in claim 16, wherein said coating includes a second component ranging from about 0.01% to about 99.99% of said coating and selected from a group including pigments, dies, starches, waxes, silicones, stabilizers, drying aids, fragrances and combinations thereof.

18. A business communication assembly suitable for use as a presentation folder as recited in claim 16, wherein said curable coating is cured by UV energy.

19. A business communication assembly suitable for use as a presentation folder as recited in claim 16, wherein said coating has a thickness ranging from about 0.0002″ to about 0.005″.

20. A business communication assembly suitable for use as a presentation folder as recited in claim 16, wherein said coating is substantially transparent.
